(19) United States
(12) Patent Application Publication
(10) Pub. No.: US 2018/0262721 A1
(43) Pub. Date: Sep. 13, 2018

(54) OBSERVATION DEVICE, COMMUNICATION CABLE, AND IMAGING DEVICE

(71) Applicant: OLYMPUS CORPORATION, Tokyo (JP)

(72) Inventors: Nobuyuki TANAKA, Hachioji-shi (JP); Hideaki MATSUOTO, Fuchu-shi (JP); Osamu NONAKA, Sagamihara-shi (JP)

(73) Assignee: OLYMPUS CORPORATION, Tokyo (JP)

(21) Appl. No.: 15/914,403

(22) Filed: Mar. 7, 2018

(30) Foreign Application Priority Data
Mar. 10, 2017 (JP) 2017-045852

(51) Int. Cl. H04N 7/18; H04N 5/232; G03B 17/55; H04N 7/10

(52) U.S. Cl. CPC H04N 7/183; H04N 5/23296; H04N 5/23203; H04N 7/10; G03B 17/55

(57) ABSTRACT

An observation device observes a sample. The observation device includes an imaging unit, a first moving mechanism, and a cooling unit. The imaging unit is provided in a housing of the observation device. The imaging unit images the sample. The first moving mechanism is provided in the housing. The first moving mechanism moves the imaging unit in a first direction. The cooling unit is arranged in the first moving mechanism. The cooling unit cools the imaging unit along the first direction.

### CROSS-REFERENCE TO RELATED APPLICATIONS

This application is based upon and claims the benefit of priority from the prior Japanese Patent Application No. 2017-045852, filed Mar. 10, 2017, the entire contents of which are incorporated herein by reference.

### BACKGROUND OF THE INVENTION

### 1. Field of the Invention

The present invention relates to an observation device and a communication cable used for such an observation device, etc.

### 2. Description of the Related Art

In observation devices and electronic equipment, because of increased functionality and performance of an imaging unit, etc., heat generation becomes a problem. It is desirable that heat affecting an observation target is suppressed as much as possible.

Regarding such a heat radiation technique of electronic equipment, in an electric power cable heat exchanger for a computer of Jpn. PCT National Publication No. 2001-524265, for example, a power source cable connected to a computer as electronic equipment has a heat radiation mechanism comprising a fan, etc.

### BRIEF SUMMARY OF THE INVENTION

According to a first aspect of the invention, there is provided an observation device for observing a sample, comprising: an imaging unit provided in a housing of the observation device and configured to image the sample; a first moving mechanism provided in the housing and configured to move the imaging unit in a first direction; and a cooling unit arranged in the first moving mechanism and configured to cool the imaging unit along the first direction.

According to a second aspect of the invention, there is provided a communication cable comprising a data signal line for communications between an observation device and a controller for controlling the observation device and a power line for power supply from the controller to the observation device, the communication cable comprising: a heat transfer unit configured to move heat released from an imaging unit of the observation device to the controller; and a heat radiation mechanism configured to cool the heat transfer unit.

According to a third aspect of the invention, there is provided an imaging device for imaging an object, comprising: an imaging unit provided in a housing of the imaging device and configured to image the object; a cooling unit configured to cool the imaging unit; and a heat radiation portion arranged to face the cooling unit with the imaging unit therebetween and configured to receive heat moved from the imaging unit by the cooling unit.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute apart of the specification, illustrate embodiments of the invention, and together with the general description given above and the detailed description of the embodiments given below, serve to explain the principles of the invention.

FIG. 1 is a schematic view showing an external overview of an observation system according to one embodiment.

FIG. 2 is an upper surface view of an imaging unit.

FIG. 3 is an enlarged view of the vicinity of an image processing circuit.

FIG. 4 is a block diagram showing an overview of a configuration example of an observation system according to one embodiment.

FIG. 5A is a schematic view showing an external overview of a communication cable.

FIG. 5B is a cross-sectional view of a communication cable.

FIG. 5C is a schematic view of the inside of a heat radiation portion.

FIG. 6 is an electric circuit diagram of the inside of a heat radiation portion.

FIG. 7 is a flowchart showing an example of observation device control processing according to one embodiment.

FIG. 8 is a flowchart showing an example of controller control processing according to one embodiment.

FIG. 9A is a schematic view showing an example of a display in a controller.

FIG. 9B is a schematic view showing an example of a display at the time of a specific observation in a controller.

FIG. 9C is a schematic view showing an example of a display at the time of a temperature rise in a controller.

### DETAILED DESCRIPTION OF THE INVENTION

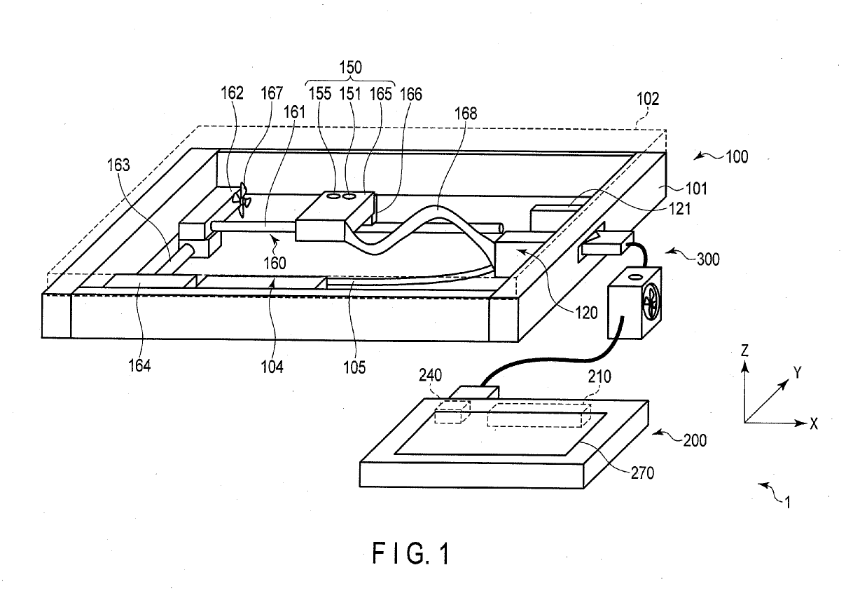

Hereinafter, one embodiment of the present invention will be described with reference to the drawings. An observation system according to the present embodiment is a system for imaging a cell, a cell group, and a tissue under culture, etc., and recording the number and forms of cells or cell groups, etc. An external overview of an observation system 1 is shown in FIG. 1 as a schematic view. As shown in FIG. 1, the observation system 1 comprises an observation device 100 and a controller 200. The observation device 100 is approximately flat-shaped as shown in FIG. 1. On an upper surface of the observation device 100, a sample being an observation target is disposed. The observation device 100 on which the sample is disposed is placed in, for example, an incubator. Namely, the sample may be put in and put out, for example, an incubator or a clean bench, while being disposed on the upper surface of the observation device 100. As such, in an observation while maintaining a constant environment, it is necessary to care about a heat generation problem in particular. In the present embodiment, such a typical example is indicated, but besides the inside of an incubator, there are many other environments which disfavor a temperature fluctuation. Thus, the application range of the present invention is not limited to the present embodiment.

A sample as a measurement target of the observation device 1 includes, for example, a vessel, a culture medium, a cell, and a reflecting plate. A culture medium is put into a vessel, and a cell is cultured in the culture medium. The vessel may be, for example, a culture dish, a culture flask, and a multiwell plate. As such, the vessel is, for example, a culture vessel for culturing a biological sample. The shape, size, etc. of the vessel are not limited. The culture medium may be a liquid culture medium or a solid culture medium. The measurement target is, for example, a cell. The measurement target may be an adhesive cell or a floating cell. In addition, the cell may be a spheroid or a tissue. Furthermore, the cell may originate from any kind of a living organism, and may originate from a bacteria, etc. As such, the sample includes a biological sample which is a living organism or a sample originating from a living organism. The reflecting plate is for reflecting an illumination light which is incident into a sample via a transparent plate to illuminate a cell, and is placed on an upper surface of a vessel. Such an illumination may also be a heat source. In a case of an enlarged observation in particular, a sample is often observed in close proximity. In addition, since the device easily produces a shadow, there are many cases where an illumination unit is provided in the vicinity of an imaging unit. Thus, it is highly likely that the illumination unit and the imaging unit may add up to be a large heat source. In the present embodiment as well, a device having such illumination unit and imaging unit is explained so that the contents of the invention can be easily understood. As a matter of course, an illumination unit may not be used. Although a cell is indicated as a substance that is easily affected by such a temperature change, the present invention is, of course, also effective in enlarged-observation of other substances.

The description of the observation system 1 will be continued. For explanation purposes, an X axis and a Y axis which are orthogonal to each other are defined on a surface parallel to a main surface of the transparent plate of the observation device 100, and a Z axis is defined to be orthogonal to the X axis and Y axis.

The observation device 100 comprises a housing 101, a transparent plate 102, and an image acquisition unit 150. The transparent plate 102 is placed on an upper surface of the housing 101. The image acquisition unit 150 is provided inside the housing 101. The image acquisition unit 150 illuminates a sample via the transparent plate 102, and images the sample to acquire an image of the sample.

The transparent plate 102 is made of, for example, glass. The sample is stood on the transparent plate 102. In FIG. 1, the whole transparent plate 102 is transparent, but may be configured to be partially transparent and be opaque in the other parts. Note that “transparent” here refers to being transparent to a wavelength of an illumination light.

A position in which the sample is disposed on the transparent plate 102 may be unified, and in order to fix the sample, a fixed frame may be put on the transparent plate 102. Here, the fixed frame is configured to, for example, have the same size as that of the transparent plate 102 so as to be arranged in a specific position with respect to the transparent plate 102. The observation device 100 is, for example, in a state where its internal portion is sealed by a member including the housing 101 and the transparent plate 102.

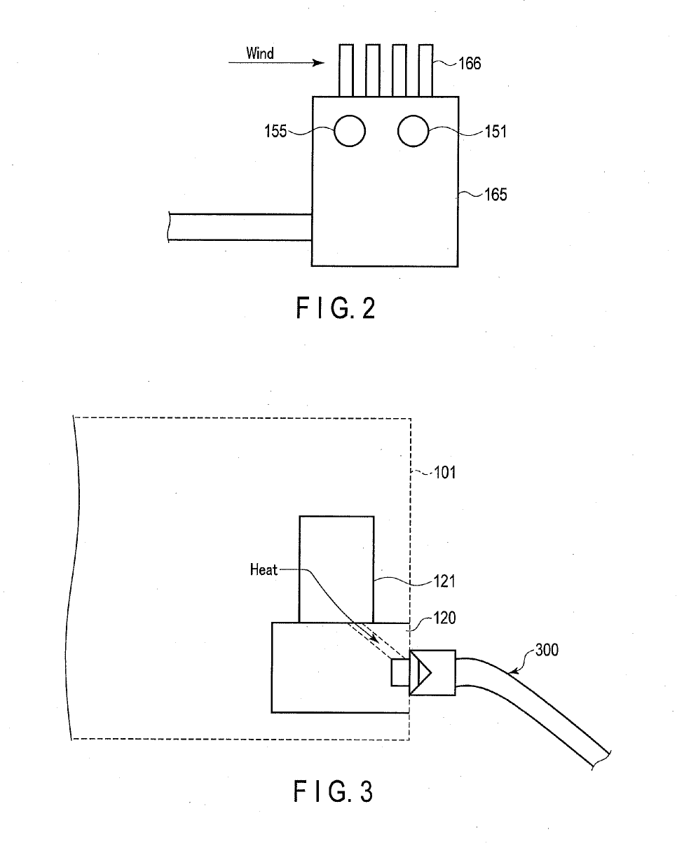

The image acquisition unit 150 comprises an imaging unit 151, an illumination unit 155, a support member 165, and a fin 166. As shown in FIG. 1, the illumination unit 155 is provided in the support member 165, and the imaging unit 151 is provided in the vicinity of the illumination unit 155. The illumination unit 155 emits an illumination light in a direction of the transparent plate 102, i.e., in a direction of the sample being disposed. In addition, the imaging unit 151 images in the direction of the sample to acquire an image of the sample. The fin 166 is made of a material with high thermal conductivity, such as silver, copper, and aluminum. The fin 166 is, for example, attached to the support member 165 of the image acquisition unit 150 as shown in FIG. 2 so as to receive a wind from the fan 167 as a cooling unit to be described later. The fin 166 may be formed integrally with the support member 165. During observation by the observation device 100, the imaging unit 151 repeats imaging of the sample. Due to this, the imaging unit 151 generates heat. In addition, since the illumination unit 155 emits an illumination light during imaging of the imaging unit 151, the illumination unit 155 also generates heat. There is a concern that the heat of the imaging unit 151 and illumination unit 155, depending on the amount of the heat, may cause damage, such as a heat shock, to cells in the sample. On the other hand, the housing 101 is configured to be airtight, and thus heat generated in the image acquisition unit 150 easily builds up inside the housing 101.

Accordingly, in the present embodiment, a heat radiation mechanism is provided inside the housing 101. Namely, by a wind from the fan 167 being received by the fin 166, heat radiated from the fin 166 due to the heat generation of the imaging unit 151 and the illumination unit 155 is moved toward a direction of the image processing circuit 120. As will be described later, a heat radiation mechanism is also provided between the image processing circuit 120 and the communication cable 300. The heat delivered from the image acquisition unit 150 is radiated by the image processing circuit 120 and the communication cable 300. In this way, the heat of the imaging unit 151 and the illumination unit 155 is suppressed by air cooling the imaging unit 151 and the illumination unit 155 by the fan 167 in the present embodiment.

The observation device 100 further comprises a moving mechanism 160. The moving mechanism 160 comprises an X feed screw 161, and an X actuator 162 as the first moving mechanism. The X feed screw 161 and the X actuator 162 move the support member 165 in the X axis direction. In addition, the moving mechanism 160 comprises a Y feed screw 163, and a Y actuator 164 as the second moving mechanism. The Y feed screw 163 and the Y actuator 164 move the support member 165 in the Y axis direction.

Furthermore, the moving mechanism 160 comprises the fan 167. The fan 167 is attached to the X actuator 162 and blows a wind along the X axis direction so that it can apply a wind to the image acquisition unit 150 even if the image acquisition unit 150 moves in the X axis direction or the Y axis direction. The X actuator 162 is attached to the Y feed screw 163, and moves in the Y axis direction when the Y actuator 164 is driven to move the support member 165 in the Y axis direction. Accordingly, a relative position of the fan 167 and the support member 165 in the Y axis direction would not change. On the other hand, when the X actuator 162 is driven to move the support member 165 in the X axis direction, a relative position of the fan 167 and the support member 165 in the X axis direction changes. However, since the fan 167 blows a wind toward the X axis direction, the wind from the fan 167 would be applied to the support member 165 of the image acquisition unit 150 even if the relative position of the fan 167 and the support member 165 changes. Note that in FIG. 1, the fan 167 is attached to the X actuator 162, but as long as the fan 167 can keep applying a wind to the support member 165 even if it moves, the fan 167 may not necessarily be attached to the X actuator 162. For example, a moving mechanism for moving the fan 167 may be provided separately from the moving mechanism 160.

An imaging position in the Z direction is changed by a focusing position of the imaging unit 151 being changed. Namely, instead of changing the focusing position of the imaging unit 151, the moving mechanism 160 may comprise a Z feed screw, a Z actuator, etc. for moving the support member 165 in the Z axis direction.

In this way, the observation device 100 performs imaging repeatedly while causing the moving mechanism 160 to change the position of the image acquisition unit 150 in the X direction and Y direction to acquire a plurality of images. In addition, the observation device 100 synthesizes these images to generate one image. The image generated thereby is, for example, an image indicating a surface vertical to an optical axis of the imaging unit 151, i.e., a surface parallel with the transparent plate 102. Furthermore, the observation device 100 repeatedly performs imaging while changing the imaging position in a thickness direction and changing the position in the X direction and Y direction. Then, the observation device 100 synthesizes a result of the imaging to sequentially acquire an image in each of the Z direction positions. Herein, the thickness direction is the Z axis direction which is the optical axis direction of the imaging unit 151, and is a direction vertical to the transparent plate 102. In this way, an image in each three-dimensional portion is acquired.

The example here is of repeating imaging while changing the imaged surface in the Z direction, but without acquiring a plurality of images in the Z direction; imaging may be performed repeatedly while changing the position in the X direction and Y direction only. In this case, a synthesized image of one plane can be acquired. Note that regarding a method for acquiring images in a plurality of Z direction positions, the position in the Z axis direction may be fixed to scan in the X direction and Y direction, and the position in the Z axis direction may then be changed to scan in the X direction and Y direction again. In addition, imaging may be performed multiple times while changing the position in the Z axis direction per one position in the X direction and Y direction, and this multiple times of imaging may also be performed while scanning in the X direction and Y direction. This can be applied to imaging of a specific point not to be scanned.

In addition, the observation device 100 further comprises a circuit group 104 as shown in FIG. 1. The circuit group 104 is provided inside the housing 101, and includes a plurality of circuits for controlling the observation device 100. Separately from the circuit group 104, the observation device 100 comprises an image processing circuit 120. The image processing circuit 120 is arranged in a position as far away as possible from the image acquisition unit 150 of the housing 101. In the example of FIG. 1, the image processing circuit 120 is positioned to face the fan 167 (the X actuator 162) with the image acquisition unit 150 therebetween in the inside of the housing 101 of the observation device 100, i.e., in the right-end portion of the housing 101. Then, the image processing circuit 120 is electrically connected to the image acquisition unit 150 via the cable 168, and is electrically connected to the circuit group 104 via the cable 105.

The image processing circuit 120 is a circuit with a large heat generation amount like the imaging unit 151 and the illumination unit 155 of the image acquisition unit 150. Thus, by arranging the image acquisition unit 150 and the image processing circuit 120, which become heat sources, apart from each other, an excessive rise in temperature of the observation device 100 can be suppressed. In addition, a heat radiation portion 121 is provided in the image processing circuit 120 as shown in FIG. 3. The heat radiation portion 121 is, for example, a silver plate, and is attached to the image processing circuit 120. The heat radiation portion 121 delivers heat delivered from the support member 165 to the communication cable 300 via the image processing circuit 120. Note that the heat generated in the image processing circuit 120 is delivered to the communication cable 300 without via the heat radiation portion 121.

A partition made of a heat insulating material may be provided between the image acquisition unit 150 and the image processing circuit 120. By such a configuration, it is possible to suppress the heat generated in the image processing circuit 120 from being delivered to the image acquisition unit 150.

In the example of FIG. 1, the circuit group 104 and the image processing circuit 120 are separately arranged, but the circuit group 104 may also be positioned in the position of the image processing circuit 120.

The air cooling mechanism described above may be applicable general imaging devices without the moving mechanism 160 of the imaging unit 151. When the heat radiation portion 121 is provided to face the fan 167 with the image acquisition unit 150 therebetween, heat escaped by applying a wind to the imaging unit 150 is diffused and moved to the heat radiation portion 121.

The image processing circuit 120 is connected to the controller 200 via the communication cable 300. In the example of FIG. 1, communications between the observation device 100 and the controller 200 are performed via the communication cable 300 and the image processing circuit 120. Details of the communication cable 300 will be described later.

The controller 200 is provided, for example, outside an incubator. The controller 200 controls the operation of the observation device 100 while communicating with the observation device 100 via the communication cable 300. The controller 200 is, for example, a personal computer (PC), or a tablet-type information terminal. FIG. 1 illustrates a tablet-type information terminal. The controller 200 is provided with an input/output device comprising a display such as a liquid crystal display and an input device such as a touch panel. Besides the touch panel, the input device may include a switch, a dial, a keyboard, a mouse, etc. In addition, a controller side communication device 240 is provided in the controller 200. The controller side communication device 240 is a device for communicating with the observation device 100. A controller side control circuit 210 for controlling the controller 200 is also provided in the controller 200.

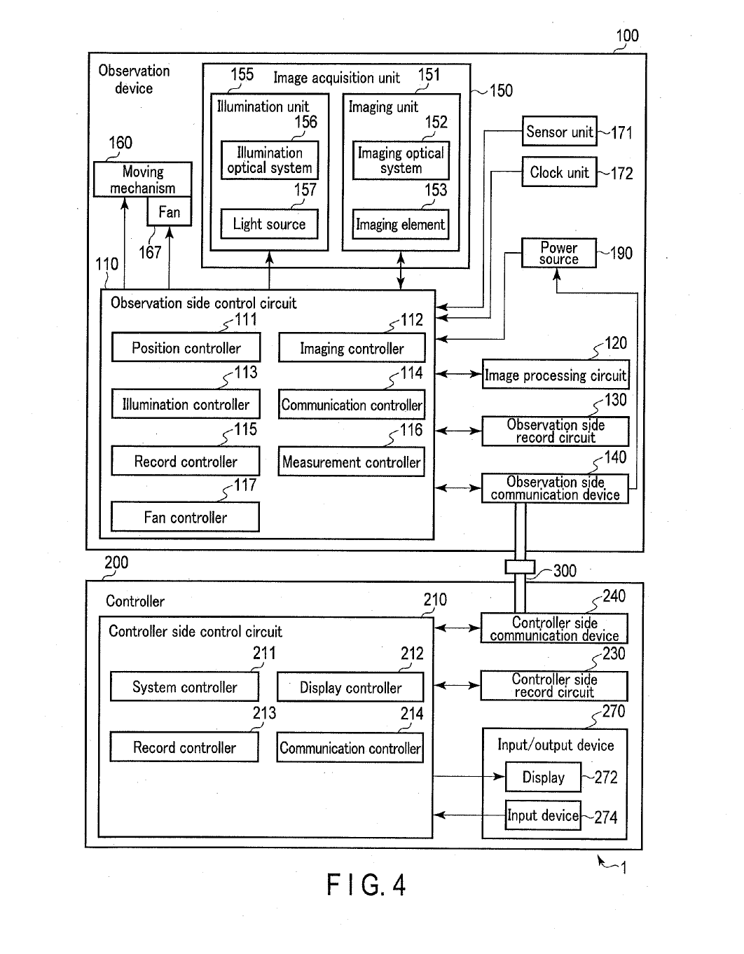

FIG. 4 is a block diagram showing an overview of a configuration example of an observation system according to one embodiment. Note that descriptions of the aforementioned configurations will be omitted as appropriate. As shown in FIG. 4, the imaging unit 151 of the image acquisition unit 150 includes an imaging optical system 152 and an imaging element 153. The imaging unit 151 generates image data based on an image formed on an imaging surface of the imaging element 153 via the imaging optical system 152. The imaging optical system 152 is preferably an optical system with an adjustable focal point and a zooming optical system with a changeable focal length. The illumination unit 155 comprises an illumination optical system 156 and a light source 157. An illumination light emitted from the light source 157 is applied to the sample via the illumination optical system 156. As mentioned above, the imaging unit 151 and the illumination unit 155 are highly likely to generate heat, and are thus cooled by the fan 167.

The observation device 100 comprises an observation side record circuit 130. The observation side record circuit 130 is provided in the circuit group 104, and records, for example, programs and various parameters used in each unit of the observation device 100, moving patterns and scan patterns of the image acquisition unit 150, and data obtained in the observation device 100, etc. In addition, the observation side record circuit 130 temporarily records various data, such as image data (pixel data), image data for recording, image data for display, and processing data during operation. Note that data obtained in the observation device 100 recorded in the observation side record circuit 130 includes, for example, a measurement value of measurement, a starting condition of measurement, an acquired image, an imaging position, an imaging condition, and an analysis result.

In addition, as mentioned above, the observation device 100 comprises the image processing circuit 120. The image processing circuit 120 applies various image processing to image data obtained in the imaging unit 151. Data after image processing by the image processing circuit 120 is, for example, recorded in the observation side record circuit 130 or transmitted to the controller 200. The image processing circuit 120 may perform various analyses based on the acquired image. For example, the image processing circuit 120 extracts an image of a cell or a cell group included in the sample and calculates the number of cells or cell groups based on the acquired image. The analysis result obtained in this way is, for example, recorded in the observation side record circuit 130 or transmitted to the controller 200.

The observation device 100 also comprises an observation side communication device 140. The observation side communication device 140 is provided in the circuit group 104, and is a device for communicating with the controller 200. For this communication, communication by wire via the communication cable 300 is used.

The observation device 100 also comprises a sensor unit 171. The sensor unit 171 includes a temperature sensor. The sensor unit 171 performs, for example, measurements of temperature and humidity based on a control signal output by a measurement controller 116. Note that the temperature sensor includes a plurality of temperature sensors so as to measure the temperature of, for example, the inside of the housing 101 of the observation device 100, in particular, the periphery of the image acquisition unit 150 and the image processing circuit 120, the housing 101, and the transparent plate 102. The sensor 171 may comprise sensors other than the temperature sensors, such as a humidity sensor and a pressure sensor.

The observation device 100 further comprises an observation side control circuit 110, a clock unit 172, and a power source 190. The observation side control circuit 110 controls the operation of each unit in the observation device 100. In addition, the observation side control circuit 110 performs various controls of the observation device 100. As shown in FIG. 4, the observation side control circuit 110 has functions as a position controller 111, an imaging controller 112, an illumination controller 113, a communication controller 114, a record controller 115, a measurement controller 116, and a fan controller 117. The position controller 111 controls the operation of the moving mechanism 160, and controls the position of the image acquisition unit 150. The imaging controller 112 controls the operation of the imaging unit 151 in the image acquisition unit 150. The illumination controller 113 controls the operation of the illumination unit 155 in the image acquisition unit 150. The communication controller 114 manages communications with the controller 200 via the observation side communication device 140. The record controller 115 controls recording of the data obtained in the observation device 100. The measurement controller 116 controls the overall measurements, such as the timing of and the number of times of performing measurements. The fan controller 117 controls the operation of the fan 167. The fan controller 117 starts the operation of the fan 167 when, for example, a rise in temperature of the image acquisition unit 150 is detected. Furthermore, the fan controller 117 controls the operation of a cable fan provided in the communication cable 300 to be described later.

The clock unit 172 generates time information, and outputs it to the observation side control circuit 110. This time information is used, for example, for determination of the operation of the observation device 100 at the time of recording of the acquired data.

Having received an electric power supply from the controller 200 via the communication cable 300, the power source 190 supplies the electric power to each unit in the observation device 100. Note that the power source 190 may include, for example, a battery such as a lithium ion battery, or an external power supply and a battery used in combination.

As described above, by providing the image acquisition unit 150 that generates image data by imaging via the transparent plate 102 and the moving mechanism 160 that moves the image acquisition unit 150 inside the housing 101, the device can be made to have a structure which is highly reliable, easy to handle and clean, and capable of preventing contamination, etc.

The controller 200 comprises a controller side record circuit 230. The controller side record circuit 230 records, for example, programs and various parameters used in the controller side control circuit 210. In addition, the controller side record circuit 230 records data obtained in the observation device 100 and received from the observation device 100.

The controller side control circuit 210 has functions as a system controller 211, a display controller 212, a record controller 213, and a communication controller 214. The system controller 211 performs various computations for control for measurement of the sample. The display controller 212 controls the operation of a display 272. The display controller 212 displays necessary information, etc. on the display 272. The record controller 213 controls recording of information in the controller side record circuit 230. The communication controller 214 controls communications with the observation device 100 via the controller side communication device 240.

Note that the observation side control circuit 110, the image processing circuit 120, and the controller side control circuit 210 include an integrated circuit, such as a Central Processing Unit (CPU), an Application Specific Integrated Circuit (ASIC), or a Field Programmable Gate Array (FPGA). The observation side control circuit 110, the image processing circuit 120, and the controller side control circuit 210 may be each constituted by a single integrated circuit, etc., or by a combination of a plurality of integrated circuits, etc. In addition, the observation side control circuit 110 and the image processing circuit 120 may be constituted by a single integrated circuit, etc. Furthermore, the position controller 111, the imaging controller 112, the illumination controller 113, the communication controller 114, the record controller 115, the measurement controller 116, and the fan controller 117 of the observation side control circuit 110 may be each constituted by a single integrated circuit, etc., or by a combination of a plurality of integrated circuits, etc. Two or more of the position controller 111, the imaging controller 112, the illumination controller 113, the communication controller 114, the record controller 115, the measurement controller 116, and the fan controller 117 may be constituted by a single integrated circuit, etc. Similarly, the system controller 211, the display controller 212, the record controller 213, and the communication controller 214 of the controller side control circuit 210 may be each constituted by a single integrated circuit, etc., or by a combination of a plurality of integrated circuits, etc. Also, two or more of the system controller 211, the display controller 212, the record controller 213, and the communication controller 214 may be constituted by a single integrated circuit, etc. The operations of these integrated circuits are performed, for example, according to a program stored in the observation side record circuit 130 or the controller side record circuit 230, or a storage region in the integrated circuit.

The observation side record circuit 130, the controller side record circuit 230, or each element thereof is a nonvolatile memory, such as a flash memory, and may further have a volatile memory, such as a Static Random Access Memory (SRAM) and a Dynamic Random Access Memory (DRAM). In addition, the observation side record circuit 130 or each element thereof, and the controller side record circuit 230 or each element thereof may be each constituted by a single memory, etc., or by a combination of a plurality of memories, etc. Database, etc. outside the observation system 1 may be utilized as a part of the memory.

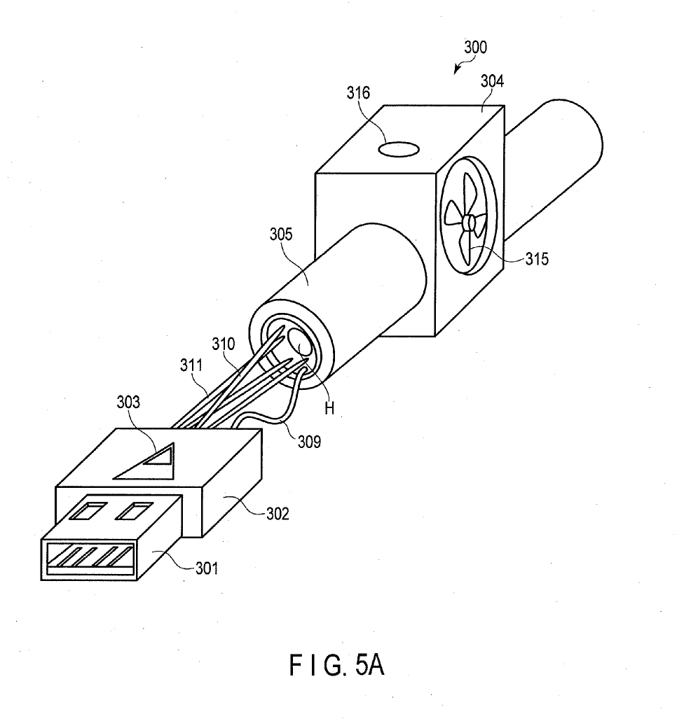

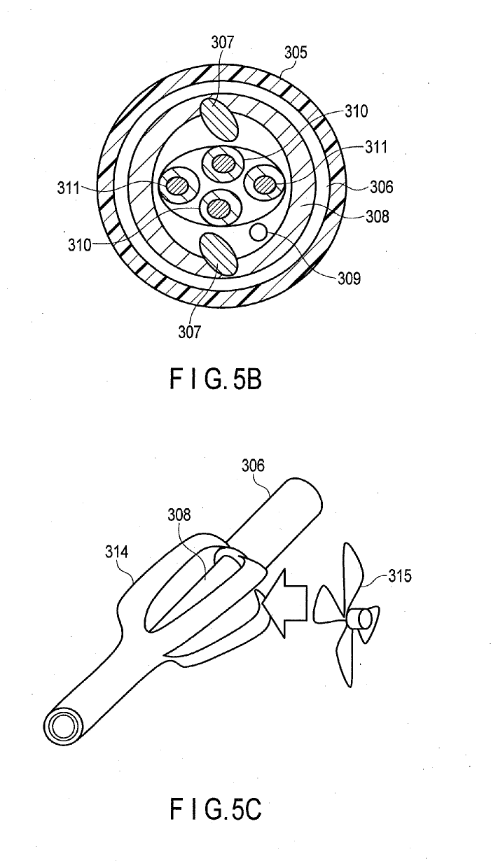

Next, the communication cable 300 will be described. The communication cable 300 is detachably connected to the image processing circuit 120 of the observation device 100. The communication cable 300 is a cable capable of performing both data communication and electric power supply, such as a USB cable. FIG. 5A is a schematic view showing an external overview of the communication cable. The communication cable 300 has a connecting fitting 301, a connector 302, a heat radiation mechanism 304, and a coating portion 305. Note that the communication cable 300 may be configured to be undetachable from the image processing circuit 120.

The connecting fitting 301 is provided at one end of the communication cable 300, and is a portion to be connected to a connecting fitting provided in the image processing circuit 120. This connecting fitting 301 receives heat from the heat radiation portion 121 when being connected to the image processing circuit 120. The connecting fitting 301 also receives heat generated in the image processing circuit 120.

The connector 302 is formed by an insulating material to cover the perimeter of the connecting fitting 301. The connector 302 is a portion held by a user when connecting the communication cable 300 to the image processing circuit 120. A heat radiation mark 303 is formed on this connector 302. The heat radiation mark 303 is formed by being inscribed on or affixing a seal, etc. to the connector 302. This heat radiation mark 303 is a mark for making the user aware of a heat radiation direction (a direction of a flow of heat) in the observation system 1. For example, the heat radiation mark 303 is an arrowhead-shaped mark, and indicates that heat flows in a direction of a distal end of the arrowhead. In the example of FIG. 5A, it is indicated that the heat radiation direction is a direction from the observation device 100 toward the controller 200.

The heat radiation mechanism 304 is provided in the middle of the communication cable 300, and cools the communication cable 300. The heat radiation mechanism 304 is desirably arranged in a place which is viewable from the user outside the incubator. This is for allowing the user to view a display of an indicator provided in the heat radiation mechanism 304. Details of the heat radiation mechanism 304 will be described later.

The coating portion 305 is, for example, a coating portion of the communication cable 300 formed by vinyl chloride. The coating portion 305 prevents the signal lines, etc. inside the communication cable 300 from being exposed outside. Herein, in FIG. 5A, a part of the coating portion 305 is removed. This is for illustrating a state of the signal lines inside the communication cable 300. In reality, the coating portion 305 maybe formed over the entire communication cable 300, as shown in FIG. 1.

FIG. 5B is a cross-sectional view of the communication cable 300. As shown in FIG. 5B, a copper braided shield 306 is provided in the inner radius of the coating portion 305. The copper braided shield 306 is provided to prevent mixing of noise from the outside of the communication cable 300. A protrusion-shaped earth line 307 is formed in the copper braided shield 306. The earth line 307 functions as an earth line in the communication cable 300. The earth line 307 is formed into a protrusion shape, and thus has an effect of making heat radiation inside the communication cable 300 easy to occur.

A silver-plated aluminum foil layer 308 is formed in the inner radius of the copper braided shield 306. The aluminum foil layer 308 suppresses releasing of the heat to the outside of the communication cable 300 by reflecting the heat toward the inside of the communication cable 300.

A heat transfer portion 309 is provided in the communication cable 300. The heat transfer portion 309 is a wire-shaped or rod-shaped member constructed of a heat conductive member, such as silver, and is thermally connected to the connecting fitting 301. The heat transfer portion 309 delivers heat delivered to the connecting fitting 301 to the heat radiation mechanism 304. Note that the heat transfer portion 309 may only need to extend to the heat radiation mechanism 304. This is for suppressing the flow of the heat into the controller 200.

A pair of data signal lines 311 and a pair of power lines 312 are formed at the central portion (core) of the communication cable 300. Each of one end of these data signal lines 311 and the power lines 312 is connected to the image processing circuit 120 via the connecting fitting 301. Each of the other end of the data signal lines 311 and the power lines 312 is connected to the controller 200. The data signal lines 311 are signal lines for communicating various data between the observation device 100 and the controller 200. The power line 312 is a power line for supplying power to the observation device 100 from the controller 200. The observation device 100 is driven by the electric power supplied via the power line 312.

Herein, a space H formed between the core of the communication cable 300 and the silver-plated aluminum foil layer 308 may be insulated by a resin layer, etc., or insulated by an air space. In a case where the inside of the space H is constituted by an air space, the inside of the space H may be configured to be air-cooled by a wind of a cable fan to be described later. Namely, the communication cable 300 can also be regarded as a communication cable having a heat transfer controller which intercepts or mitigates the heat transfer between the observation device 100 and the controller 200.

FIG. 5C is a schematic view of the inside of the heat radiation mechanism 304. Inside the heat radiation mechanism 304, the coating portion 305 is not provided for the communication cable 300, and the copper braided shield 306 is uncovered. The cable fan 315 is provided inside the heat radiation mechanism 304, and a portion 314 of the copper braided shield 306, which receives a wind from the cable fan 315, is opened into a fin shape so that the silver-plated aluminum foil layer 308 is exposed. By such a configuration, the wind from the cable fan 315 is applied to the silver-plated aluminum foil layer 308, and the communication cable 300, in particular the heat transfer portion 309, is air-cooled.

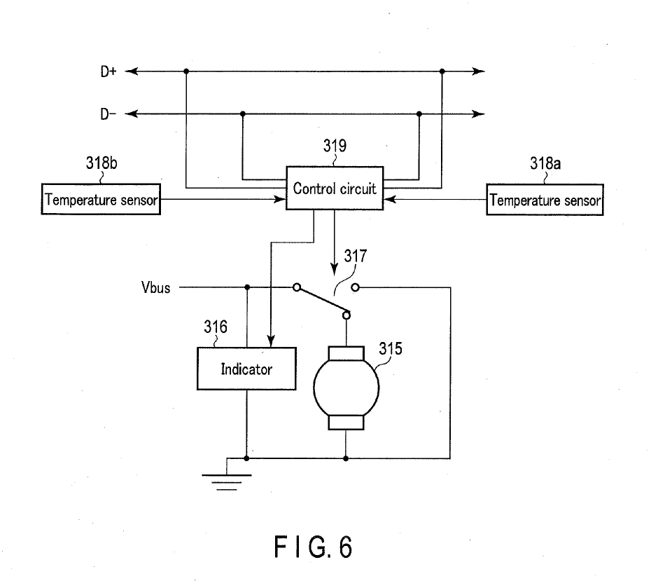

FIG. 6 is an electric circuit diagram of the heat radiation mechanism 304. As shown in FIG. 6, the heat radiation mechanism 304 has the cable fan 315, an indicator 316, a switch 317, temperature sensors 318a and 318b, and a control circuit 319.

The cable fan 315 is connected to a power line Vbus (the aforementioned power line 312) via the switch 317. This cable fan 315 is driven by power supply from the power line Vbus when the switch 317 is turned on. As shown in FIG. 5C, the wind from the cable fan 315 is configured to be applied to the aluminum foil layer 308.

The indicator 316 is, for example, an LED, and connected to the power line Vbus (the aforementioned power line 312) to be turned on by receiving a signal from the control circuit 319. The indicator 316 is, for example, turned on at the time of driving of the cable fan 315 to let the user recognize that the cable fan 315 is operating. The indicator 316 may be configured to change the lighting color according to a state of the operation of the cable fan 315. For example, the lighting color may be changed when a heat radiation effect of the cable fan 315 is not sufficient, etc.

The switch 317 turns on or off by receiving a control signal of the control circuit 319. When turned on, the switch 317 connects the power line Vbus (the aforementioned power line 312) and the cable fan 315. At this time, the driving of the cable fan 315 is started. On the other hand, the switch 317 disconnects the power line Vbus (the aforementioned power line 312) and the cable fan 315 when turned off. At this time, the driving of the cable fan 315 is stopped.

The temperature sensor 318a is provided on the observation device 100 side in the heat radiation mechanism 304, and detects the temperature of the observation device 100 side of the communication cable 300. The temperature sensor 318b is provided on the controller 200 side in the heat radiation mechanism 304, and detects the temperature of the controller 200 side of the communication cable 300.

The control circuit 319 is constituted by, for example, a CPU, and compares an output of the temperature sensor 318a and an output of the temperature sensor 318b to determine a temperature gradient (temperature difference) of the communication cable 300. Then, the control circuit 319 controls the switch 317 so that the temperature gradient of the communication cable 300 becomes small to drive the cable fan 315. The control circuit 319 is connected to data signal lines D+ and D− (the aforementioned data signal lines 311). The control circuit 319 controls the switch 317 to drive the cable fan 315 when receiving a fan control signal from the controller 200. Namely, the communication cable 300 becomes a communication cable having a heat transfer controller that mitigates the, heat transfer between the observation device 100 and the controller 200.

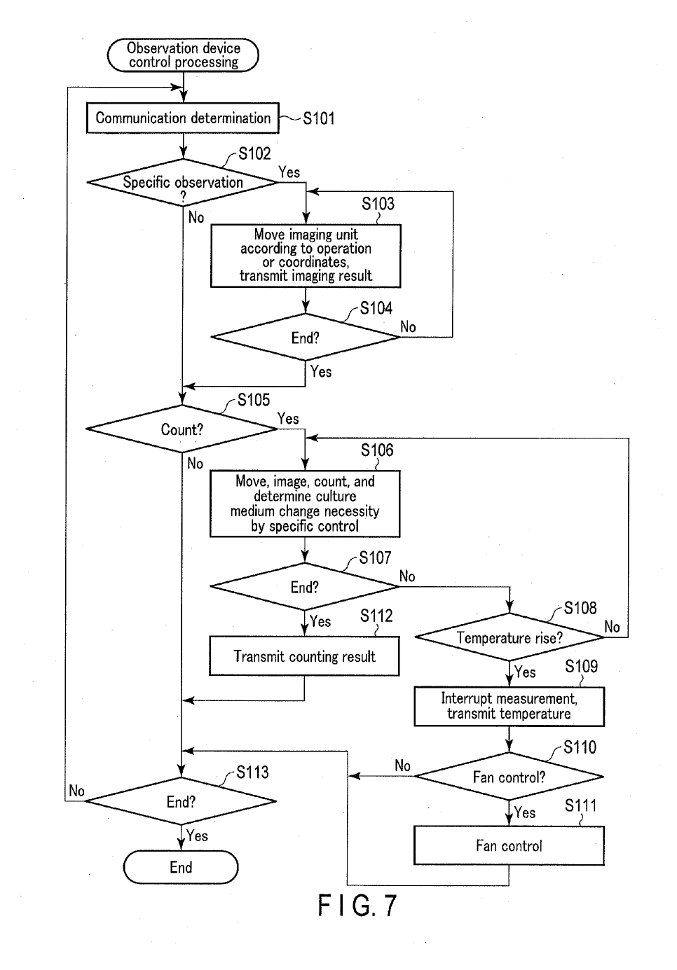

Next, the operation of the observation system 1 will be described. FIG. 7 is a flowchart showing an example of observation device control processing performed while communicating with the controller 200. The observation device control processing of FIG. 7 is started when the power source of the observation device 100 is turned on. As the case where the power supply of the observation device 100 is turned on, for example, there is a case where the user operates a power switch in the power source 190, a case of being connected to an external power source, and a case where the time set has been reached. In addition, for example, the power source may be turned on in a case of receiving a control signal to turn on the power source from the controller 200 according to a user's operation.

In step S101, the observation side control circuit 110 stands by until receiving a control signal relating to the operation, various settings, etc. of the observation device 100 from the controller 200. When receiving a control signal, the observation side control circuit 110 determines the content of the received control signal.

In step S102, the observation side control circuit 110 determines whether or not a control signal to instruct execution of a specific observation is received from the controller 200. The specific observation is observation and measurement that the user performs by specifying a specific position. For example, the user operates the controller 200 while viewing a live view display to specify a region that the user wishes to observe, or inputs position coordinates indicating the region to the controller 200 to specify the region. The control signal to instruct the execution of the specific observation includes, for example, an operation moving signal or a coordinate signal for moving the image acquisition unit 150 to a position to perform the specific observation. The operation moving signal is based on a result of the user operating the controller 200 while viewing the live view display. The coordinate signal is based on the position coordinates indicating the region input by the user. The observation device control processing proceeds to step S103 if it is determined that a control signal to instruct the execution of the specific observation is received, and proceeds to step S105 if it is determined that a control signal to instruct the execution of the specific observation is not received.

In step S103, the observation side control circuit 110 moves the image acquisition unit 150 to the moving mechanism 160 according to the operation moving signal or the coordinate signal based on the operation of the user, which is received from the controller 200. The observation side control circuit 110 causes the image acquisition unit 150 to image in a position after moving, and causes the observation side communication device 140 to transmit the acquired image to the controller 200.

In step S104, the observation side control circuit 110 determines whether or not to end the specific observation. It is determined to end the specific observation, for example, when receiving a control signal to instruct the ending according to the user's operation from the controller 200. The observation device control processing proceeds to step S105 if it is determined to end the specific observation, and returns to step S103 if it is determined not to end the specific observation.

In step S105, the observation side control circuit 110 determines whether or not a control signal to instruct the execution of count processing is received from the controller 200. The observation device control processing proceeds to steps S106 if it is determined that a control signal to instruct the execution of the count processing is received, and proceeds to step S113 if it is determined that a control signal to instruct the execution of the count processing is not received.

In step S106, the observation side control circuit 110 executes the count processing. In the count processing, the observation side control circuit 110, for example, causes the moving mechanism 160 to move the image acquisition unit 150 according to a moving pattern recorded in the observation side record circuit 130. The image acquisition unit 150 acquires images by repeatedly imaging for every predetermined position while being moved. The observation side control circuit 110 records the acquired images, etc. in the observation side record circuit 130. Furthermore, the observation side control circuit 110 causes, for example, the image processing circuit 120 to analyze the images acquired by the image acquisition unit. The observation side control circuit 110, for example, counts the number of cells, evaluates a state of the cell (for example, whether the cell is weakened or not, whether the cell is alive or not) based on a result of analyzing the images, and evaluates a state of a culture medium including the color of the culture medium to evaluate whether it is in a state where the culture medium needs to be changed or not. When it is determined that the culture medium needs to be changed as a result of this evaluation, that effect is transferred to the controller 200. At this time, an alert to urge the culture medium change is issued on the display 272 of the controller 200.

The observation side control circuit 110 may cause the moving mechanism 160 to move the image acquisition unit 150 to take an image for every predetermined position, and perform scan processing to scan the entire or a part of the sample, according to a scan pattern recorded in the observation side record circuit 130. For example, if the scan processing is performed before the count processing, the observation side control circuit 110 specifies a position of a vessel and ascertains distribution of the cells in the vessel, based on a result of analyzing images acquired by the image acquisition unit 150 so that the region for the count processing can be limited and the time required for the processing can be reduced. In addition, the user can easily check the state of the sample by the execution of the scan processing.

The observation side control circuit 110 causes the observation side communication device 140 to transmit the images to the controller 200. The state of the culture medium may be determined by analyzing the images acquired by the scan processing. Note that the count processing and scan processing may be, for example, performed integrally as measurement processing.

In step S107, the observation side control circuit 110 determines whether or not to end the count processing. For example, it is determined to end the count processing when movement according to a predetermined moving pattern or scan pattern ends, when the preset number of times of count processing or scan processing ends, and when receiving a control signal to end the count processing according to the user's operation from the controller 200. The observation device control processing proceeds to step S112 if it is determined to end the count processing, and proceeds to step S108 if it is determined to not end the count processing.

In step S108, the observation side control circuit 110 determines whether there is a predetermined value or more of a rise in temperature of the inside of the housing 101 detected by the sensor unit 171, in particular the temperature of the image acquisition unit 150. This predetermined value is, for example, a predetermined value of a temperature rise such that its effect on the cell is concerned. The observation device control processing proceeds to step S109 if it is determined that there is a predetermined value or more of a rise in temperature of the image acquisition unit 150, and returns to step S106 if it is determined that there is not a predetermined value or more of a rise in temperature of the image acquisition unit 150.

In step S109, the observation side control circuit 110 interrupts the count processing. Namely, the observation side control circuit 110 stops the moving of the image acquisition unit 150 by the moving mechanism 160. The observation side control circuit 110 stops the imaging by the image acquisition unit 150. Thereafter, the observation side control circuit 110 causes the observation side communication device 140 to transmit the temperature detected by the sensor unit 171 to the controller 200.

In step S110, the observation side control circuit 110 determines whether a control signal to instruct fan driving is received or not. The observation device control processing proceeds to step S111 if it is determined that the control signal to instruct fan driving is received, and proceeds to step S113 if it is determined that the control signal to instruct fan driving is not received.

In step S111, the observation side control circuit 110 drives the fan 167. As described above, the positions of the fan 167 and the image acquisition unit 150 in the Y axis direction are matched. Thus, regardless of in which position the image acquisition unit 150 stops, the wind from the fan 167 can be applied to the image acquisition unit 150. The observation device control processing proceeds to step S113 after the driving of the fan 167.

In step S112, the observation side control circuit 110 causes the observation side communication device 140 to transmit a result of the count processing to the controller 200.

In step S113, the observation side control circuit 110, for example, determines whether or not to end the observation device control processing according to a result of the user's operation. The case where it is determined not to end in this step includes, for example, a case where the user again instructs the execution of the specific observation or the count processing. In addition, the result of the user's operation may be obtained by each unit in the observation device 100, such as a power switch, or may be obtained via communications from the controller 200. The observation device control processing returns to step S101 if it is determined to not end the observation device control processing, and ends the processing if it is determined to end it.

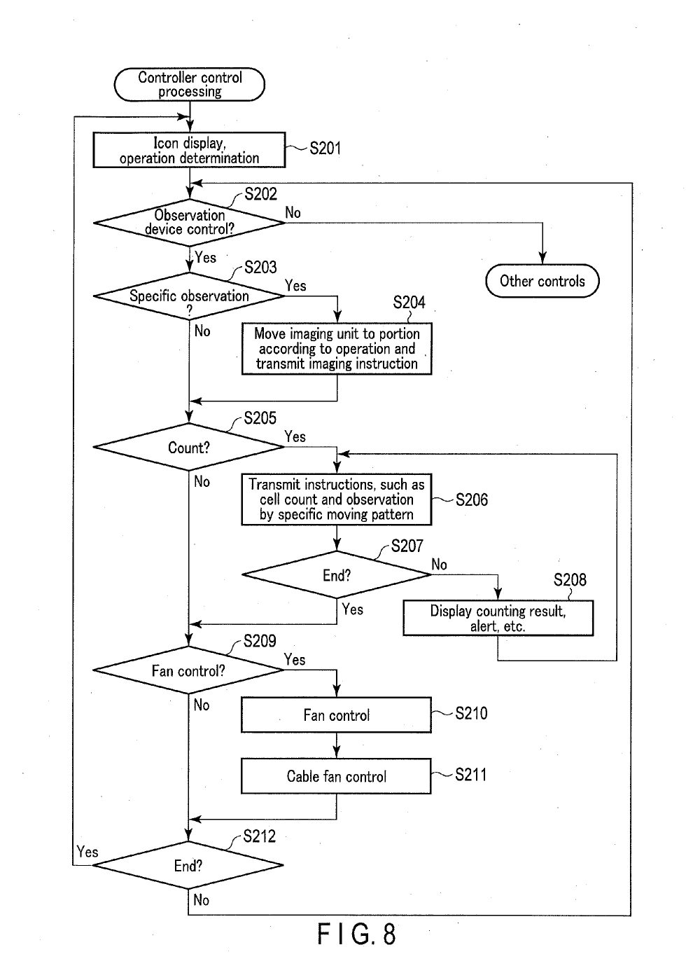

FIG. 8 is a flowchart showing an example of controller control processing performed in the controller 200. The processing shown in the flowchart of FIG. 8, for example, is started after the power of the observation device 100 is turned on.

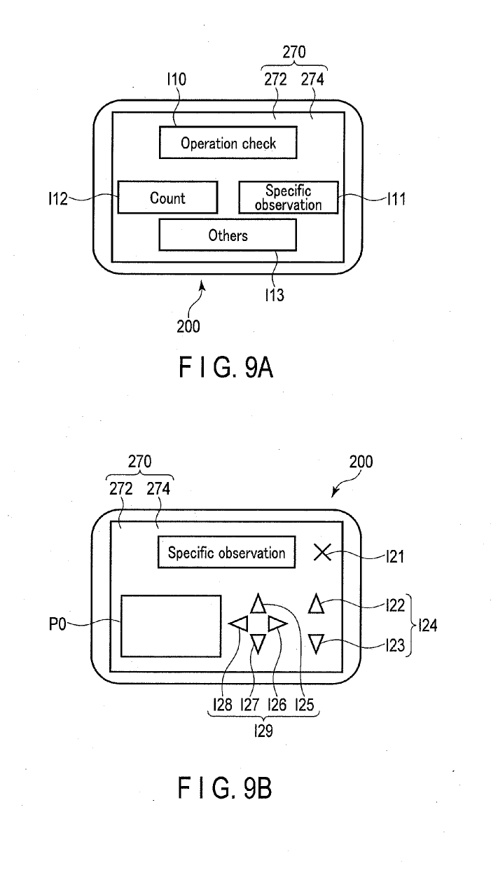

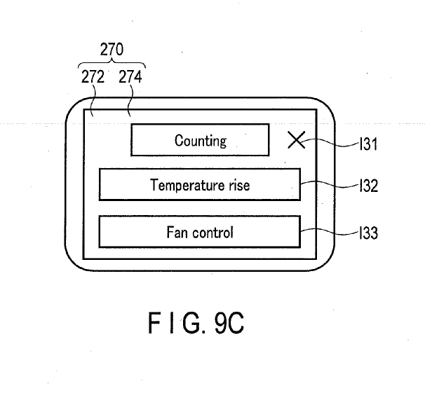

In step S201, the controller side control circuit 210 causes the display 272 in the input/output device 270 to, for example, display an icon group (basic icon) for the user to operate the observation device 100. FIG. 9A shows an example of a display in the controller 200 as a schematic view. The controller 200, as shown in FIG. 9A for example, causes the display 272 to display information including an operation check icon I10 for instructing execution of an operation check, a specific observation icon I11 for instructing execution of a specific observation, a count icon I12 for instructing execution of count processing that performs a cell count, etc., and an others icon I13 for instructing execution of the other functions or execution of various settings. The controller side control circuit 210, for example, determines (operation determination) whether the user selects an icon or not, based on an operation signal output by the input device 274 according to a result of the user's operation. The controller control processing proceeds to step S202 if it is determined that the user performs the icon selection.

In step S202, the controller side control circuit 210 determines whether or not to execute the observation device control. In this step, for example, when the specific observation icon I11 or the count icon I12 is selected, it is determined to execute the observation device control. The controller control processing proceeds to step S203 if it is determined to execute the observation device control. If it is determined not to execute the observation device control, a control other than the observation device control is performed. Namely, if the operation check icon I10 is selected, the controller side control circuit 210 performs control for the operation check of the observation device 100. If the others icon I13 is selected, the controller side control circuit 210 performs the other controls. Descriptions of details of the operation check and the other controls will be omitted.

In step S203, the controller side control circuit 210 determines whether the specific observation icon I11 is selected or not. The controller control processing proceeds to step S204 if it is determined that the specific observation icon I11 is selected, and proceeds to step S205 if it is determined that the icon is not selected.

In step S204, the controller side control circuit 210 causes the observation side communication device 140 to transmit a control signal to instruct a start of the specific observation. The controller side control circuit 210 then generates information for the specific observation, and causes the display 272 to display the information. An example of a display at the time of the specific observation in the controller 200 is shown in FIG. 9B as a schematic view. As shown in FIG. 9B, the information displayed on the display 272 at the time of the specific observation includes, for example, an icon (moving icon) I29 (consisting of Y+ moving icon I25, X+ moving icon I26, Y-moving icon I27, X-moving icon I28) for moving the moving mechanism 160. The information further includes an icon (focus adjustment icon) 124 for adjusting the focus. The icon I24 for adjusting the focus includes, for example, an icon I22 for driving a lens to an infinite side, and an icon I23 for driving the lens to a closer side. Furthermore, the display information includes an icon (return icon) I21 for instructing to return to the previous screen.

In step S204, the controller side control circuit 210 acquires images imaged and acquired by the image acquisition unit 150 from the observation device 100, and causes the display 272 to display the images. As shown in FIG. 9B, the information at the time of the specific observation further includes an image PO imaged by the image acquisition unit 150, which is acquired by the controller 200 from the observation device 100. In this state, for example, the user can operate the moving icon I29 to move the image acquisition unit 150 to a desired observation position, and after moving, can observe a state of the cell, etc. by adjusting the observation position in the Z direction by the focus adjustment icon I24. Note that the user, for example, operates the observation position, etc. while viewing the image P0 acquired by the image acquisition unit 150 and live-view displayed. Every time this operation is performed, the controller side control circuit 210 causes the observation side communication device 140 to transmit a control signal regarding the specific observation. Note that the information displayed in the specific observation may include an imaging icon for instructing recording of an image in a discretionary observation position, and may include position information indicating which position of the sample the current image acquisition unit 150 is imaging.

In step S205, the controller side control circuit 210 determines whether the count icon I12 is selected or not. The controller control processing proceeds to step S206 if it is determined that the count icon I12 is selected, and returns to step S209 if it is determined that the count icon I12 is not selected.

In step S206, the controller side control circuit 210 outputs a control signal to instruct execution of the count processing to the observation device 100.

In step S207, the controller side control circuit 210 determines whether or not to end the count processing. It is determined to end the count processing in this step if a moving pattern for counting or observation ends, etc. If it is determined to be ended, the controller side control circuit 210 causes the observation side communication device 140 to transmit a control signal to end the count processing. The controller control processing then proceeds to step S209. If it is determined not to end, the controller control processing proceeds to step S208.

In step S208, the controller side control circuit 210 acquires images imaged by the image acquisition unit 150 during the count processing, and causes the display 272 to display the images. Note that the display of the acquired images performed herein may be performed as a live view display. In step S208, the controller side control circuit 210 acquires images, a result of the count processing, etc. from the observation device 100, and causes the display 272 to display them. The controller side control circuit 210 also determines whether or not a culture medium change is needed, and displays an alert as needed. Note that the determination on whether or not a culture medium change is needed may be performed by the observation device 100, or may be performed by the controller 200. The controller control processing then returns to step S206.

In step S209, the controller side control circuit 210 determines whether or not to perform fan control. For example, when information of temperature is transmitted from the observation device 100, the controller side control circuit 210 generates information for an alert that there is a rise in temperature of the observation device 100, and causes the display 272 to display the information. An example of a display of an alert that there is a temperature rise in the controller 200 is shown in FIG. 9C as a schematic view. As shown in FIG. 9C, the information displayed on the display 272 at the time of alerting includes, for example, a message I32 indicating that there is a temperature rise. The information includes an icon (fan control icon) I33 for performing fan control. The information further includes an icon I31 (return icon) for instructing to return to the previous screen. The user sees the message I32 to determine the necessity of the fan control. The user then selects the fan control icon I33 when the fan control is needed. By this selection, it is determined to perform the fan control. The controller control processing proceeds to step S210 if it is determined to perform the fan control, and proceeds to step S212 if it is determined to not perform the fan control. Note that in step S209, if there is a predetermined temperature rise, it may be configured to determine to perform the fan control without the user's confirmation. Such a fan control may be performed by the user manually or performed automatically, but there are various factors associated with the temperature rise and the degree of resistance to, and effect of, the temperature will vary depending on a sample. Thus, parameters relating to brightness of the illumination and the kind and usage environment of the sample may be analyzed, and an artificial intelligence may perform more advanced determination.

In step S210, the controller side control circuit 210 causes the observation side communication device 140 to transmit a control signal for the fan control. In step S211, the controller side control circuit 210 causes the observation side communication device 140 to transmit a control signal for the cable fan control. The control signal for the fan control is input into the observation device 100 via the data signal line 311 of the communication cable 300. Receiving this, the observation side control circuit 110 of the observation device 100 drives the fan 167. The control signal for the cable fan control is input into the control circuit 319 of the heat radiation mechanism 304 via the data signal line 311 of the communication cable 300. Receiving this, the control circuit 319 controls the switch 317 to drive the cable fan 315. The controller control processing then proceeds to step S212. Note that the control circuit 319 drives the cable fan 315 according to a temperature gradient detected from the temperature sensors 318a and 318b even if there is no control signal from the controller 200.

In step S212, the controller side control circuit 210 determines whether or not to end the observation device control. In this step, for example, if the return icon I21 is selected during the specific observation processing or if the return icon I31 is selected during the count processing, it is determined to end the observation device control. If it is determined to end the observation device control, the controller control processing returns to step S201. If it is determined not to end the observation device control, the controller control processing returns to step S202.

As described above, in the present embodiment, in order to air-cool the movable image acquisition unit 150 provided inside the air-tight housing 101, the fan 167 that blows a wind in the X axis direction is arranged in the X actuator 162 that moves the image acquisition unit 150 in the X axis direction. By this configuration, a relative position of the image acquisition unit 150 and the fan 167 in the Y axis direction does not change, and thereby applying the wind from the fan 167 to the image acquisition unit 150, regardless of the position of the image acquisition unit 150. In this way, the image acquisition unit 150 is efficiently air-cooled.

In order to receive heat from the image acquisition unit 150 delivered by the fan 167, the heat radiation portion 121 is provided to face the fan 167 with the image acquisition unit 150 therebetween in the wind sending direction of the fan 167. By such a structure, heat received in the heat radiation portion 121 can be released outside the observation device 100 via the communication cable 300.

Furthermore, the communication cable 300 is provided with the heat radiation mechanism 304 having the cable fan 315 for radiating heat that moves through the communication cable 300. By this cable fan 315, the heat radiation from the communication cable 300 is facilitated. The communication cable 300 includes the data signal lines 311 for communicating information with the controller 200 of the observation device 100. By using this data signal lines 311 also as data signal lines of a control signal for controlling the cable fan 315, the number of the data signal lines can be reduced. The communication cable 300 includes the power line 312 for supplying electric power to the observation device 100. By using this power line 312 as a power line for supplying electric power to drive the cable fan 315 and the indicator 316, the electric power for driving the cable fan 315 and the indicator 316 can be supplied from the controller 200.

Herein, in the aforementioned embodiment, the observation device 100 and the controller 200 communicate by wire communications via the communication cable 300. However, the observation device 100 and the controller 200 may communicate by wireless communications.

In the aforementioned embodiment, an alert display of a temperature rise is issued to the controller 200 and the fan control is performed after the counting is interrupted in the observation device 100. In contrast, the fan control may be configured to be performed without interrupting the counting in the observation device 100. In this case, the temperature rise alert maybe issued in step S208 of the controller control processing.

The communication cable 300 indicated in the present embodiment can be utilized as a communication cable of various equipment, in which heat radiation is necessary, other than the observation device 100.

In this embodiment, the fan 167 is attached to the X actuator 162 and is configured to blow a wind in the X axis direction, and by the Y actuator 164, the image acquisition unit 150 and the fan 167 are configured to move integrally in the Y axis direction. In contrast, the fan 167 is attached to the Y actuator 164 and is configured to blow a wind in the Y axis direction, and by the X actuator 162, the image acquisition unit 150 and the fan 167 may be configured to move integrally in the X axis direction.

In the present embodiment, a cooling unit for cooling the image acquisition unit 150 is a fan. In contrast, the cooling unit may be configured to cool the image acquisition unit 150 by water cooling.

In the present embodiment, cooling of the image acquisition unit 150, etc. is described, but by replacing the fan 167 and the cable fan 315 with a heater, it is also possible to warm the image acquisition unit 150, etc.

Indeed, the present invention is not limited to the aforementioned embodiment, and various modifications or applications may be made without departing from the spirit of the inventions. In the portions explained with simple branches of a flowchart, improvements such as putting more factors into data for determination and modifications depending on cutouts and items of concern are possible, and thus, as a matter of course, are within the patent scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An observation device for observing a sample, comprising:
an imaging unit provided in a housing of the observation device and configured to image the sample;
a first moving mechanism provided in the housing and configured to move the imaging unit in a first direction; and
a cooling unit arranged in the first moving mechanism and configured to cool the imaging unit along the first direction.

2. The observation device according to claim 1, further comprising a second moving mechanism attached to the first moving mechanism and configured to move the imaging unit together with the first moving mechanism in a second direction different from the first direction.

3. The observation device according to claim 1, further comprising a heat radiation portion arranged to face the cooling unit with the imaging unit therebetween along the first direction and configured to receive heat moved from the imaging unit by the cooling unit.

4. The observation device according to claim 3, further comprising an image processing circuit arranged to face the cooling unit with the imaging unit therebetween along the first direction and configured to process image data acquired in the imaging unit,
wherein the heat radiation portion is attached to the image processing circuit.

5. The observation device according to claim 4, further comprising a communication cable connected to the image processing circuit and comprising a data signal line for communications between the observation device and a controller for controlling the observation device via the image processing circuit, and a power line for supplying electric power to the observation device from the controller, wherein the communication cable comprises a heat transfer unit configured to move heat released from the observation device to the controller, and a heat radiation mechanism configured to cool the heat transfer unit.

6. A communication cable comprising a data signal line for communications between an observation device and a controller for controlling the observation device and a power line for power supply from the controller to the observation device, the communication cable comprising:
a heat transfer unit configured to move heat released from an imaging unit of the observation device to the controller; and
a heat radiation mechanism configured to cool the heat transfer unit.

7. The communication cable according to claim 6, wherein the heat radiation mechanism is connected to the data signal line and the power line, and cools the heat transfer unit according to control of the controller.

8. The communication cable according to claim 6, further comprising a transfer controller configured to mitigate heat transfer between the observation device and the controller.

9. An imaging device for imaging an object, comprising:
an imaging unit provided in a housing of the imaging device and configured to image the object;
a cooling unit configured to cool the imaging unit; and
a heat radiation portion arranged to face the cooling unit with the imaging unit therebetween and configured to receive heat moved from the imaging unit by the cooling unit.
